(19) United States
(12) Patent Application Publication
(10) Pub. No.: US 2006/0155797 A1
(43) Pub. Date: Jul. 13, 2006

(54) Systolic squarer having five classes of cells

(75) Inventors: Yuan-Long Jeang, Kaohsiung Hsien (TW); Jiun-Hau Tu, Taipei Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: NATIONAL KAOHSIUNG UNIVERSITY OF APPLIED SCIENCES, Kaohsiung (TW)

(21) Appl. No.: 11/030,764

(22) Filed: Jan. 7, 2005

(51) Int. Cl. G06F 7/32

(52) U.S. Cl. 708/522

(57) ABSTRACT

A systolic squarer comprises a systolic array classified into five cell modules by pipeline and regulation according to each operational circuit. According to fundamental structures, the five cell modules constitute the systolic squarer. Each of the cell modules is selected from a group consisting of plural full adders, plural half adders and plural AND gates. Thereby, the five cell modules are suitable for applying to process a great number of digital signals of data, speeding up processing time, and reducing hardware cost and power consumption.

### BACKGROUND OF THE INVENTION

1. Field of the Invention

The present invention relates to a systolic squarer having five classes of cells. More particularly, the present invention relates to the systolic squarer in classifying cell modules into five groups so as to minimize dimensions and power consumption.

2. Description of the Related Art

Squarer circuit has widely been employed in various digital signal techniques, such as Digital Signal Processing (DSP), an adaptive filter, image compression/equalization, Euclidean branch calculation, pattern recognition, vector quantization, error correction, data compression, decoding, demodulation, and Arithmetic Logic Units for microprocessor. Accordingly, there is a high utility of squarer circuit commonly used in the digital signal industry. However, the squarer circuit is applied to a high-speed operation system by means of squaring, and suitable for processing a great number of complicated data.

Generally, the booth-folding encoding techniques is used to carry out a conventional squarer circuit in employing a relatively small amount of AND gates so as to reduce power consumption. It is disadvantageous that a small amount of AND gates may slow down the response rate of the conventional squarer. Consequently, the response rate of the entire system is inefficient when the conventional squarer is used to process a great number of images and complicated data.

Another conventional squarer circuit adopts a systolic array whose fundamental structure consists of plural full adders and plural AND gates. The squarer circuit can precisely compute required data and related numerals. The squarer circuit can further employ a D flip-flop for locking (registering) data so as to permit data processing in pipelining and parallelizing manners when each lever of the squarer circuit is gradually computed. It is advantageous that the response of the squarer circuit is speeded up and data processing/compressing time is effectively saved. Inevitably, such a systolic squarer of the conventional squarer circuit results in higher power consumption and greater dimensions due to overusing the adders or AND gates.

Furthermore, when such a systolic squarer of the conventional squarer circuit is operated in compressing a great number of data, the squarer circuit must compute and output a first digital signal in advance so as to permit further computing and outputting a second digital signal in sequence. Because of this, the data processing time of the squarer circuit for processing a great deal and complex of images is prolonged. Hence, there is a need for simplifying the entire structure, reducing power consumption and speeding up the response rate of the systolic squarer.

Referring initially to FIG. 1, a graph of a multiplication algorithm used in a conventional multiplier circuit is illustrated. Similarly, there is a well-known square algorithm used in the squarer circuit. In the illustrated graph, a difference of the square algorithm from the multiplication algorithm is generally each of multipliers identical with each of multiplicands, identified as a diagonal line running from left to right in FIG. 1.

The square algorithm used in the squarer circuit can be simplified appropriately. Given is an n-bit number Z for computing a square S. An equation (1) for the square algorithm is substantially equivalent to:

$$S = {Z}^{2} = {( {\sum }_{j = 0}^{n - 1} zj {2}^{j} )}^{2} \qquad ( 1 )$$

wherein:

S is an output of the binary system;

Z is an output of the binary system; and

n is number of bit.

The equation (1) can be expanded and a new equation (2) can be rewritten as:

$$Z = {\sum }_{j = 0}^{n - 1} {x}_{j} {2}^{2 j} + {\sum }_{j = 1}^{n - 1} {\sum }_{k = 0}^{j - 1} {x}_{j} {x}_{k} {2}^{j + k} + {\sum }_{k = 1}^{n - 1} {\sum }_{j = 0}^{k - 1} {x}_{j} {x}_{k} {2}^{j + k} \qquad ( 2 )$$

wherein:

the first term represents the n partial products on the diagonal line of the partial-product array, as shown in FIG. 1. The second and third terms represents the partial products above and below the diagonal line, and are symmetric across the diagonal line. It can be found that the second and third terms commonly take the form of (n²−n)/2. However, the second and third terms are equivalent. Thus, they can be combined and a new equation (3) can be rewritten as:

$$Z = {\sum }_{j = 0}^{n - 1} {x}_{j} {2}^{2 j} + 2 \times ( {\sum }_{j = 1}^{n - 1} {\sum }_{k = 0}^{j - 1} {x}_{j} {x}_{k} {2}^{j + k} ) \qquad ( 3 )$$

The equation (3) is simplified from the square algorithm used in the squarer circuit.

Turning now to FIG. 2, a simplified structure of a systolic squarer used in a conventional squarer circuit is illustrated. In the decimal system, the squares of decimals, such as 0, 1, 2, 3 and 4, are a series of 0, 1, 4, 9 and 16. It is found that each second bit (binary digit) always outputs “zero” in a binary numeral in converting the decimal system into the binary system when a 4-bit squarer circuit is computed. Namely, each second bit always outputs “zero” in a binary numeral when any decimal is inputted and computed.

The present invention intends to provide a systolic squarer comprising a systolic array classified into five different cell modules by pipeline and regulation according to each operational circuit. The five cell modules are suitable for operating any bit of a squarer circuit so that the five cell modules can construct the systolic squarer according to their circuitry structures.

### SUMMARY OF THE INVENTION

The primary objective of this invention is to provide a systolic squarer consisting of five classes of cell modules according to their circuitry structures. The five cell modules are suitable for operating 8 or more bit of a 700 MHz-squarer circuit. Accordingly, the cell modules can perform minimizing dimensions, reducing power consumption and speeding up response rate of systolic squarer.

The systolic squarer in accordance with the present invention comprises a systolic array classified into five cell modules by pipeline and regulation according to each operational circuit. According to fundamental structures, the five cell modules constitute the systolic squarer. Each of the cell modules is selected from a group consisting of plural full adders, plural half adders and plural AND gates. Thereby, the five cell modules are suitable for applying to process a great number of digital signals of data, speeding up processing time, and reducing hardware cost and power consumption.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given which are given by way of illustration only, and thus are not limitative of the present invention, and wherein:

FIG. 1 is a graph of a multiplication algorithm used in a conventional multiplier circuit in accordance with the prior art;

FIG. 2 is a schematic diagram illustrating a simplified structure of a systolic squarer used in a conventional squarer circuit in accordance with the prior art;

FIG. 3 is a schematic diagram illustrating a simplified structure of a systolic squarer with an 8-bit structure having five classes of cells in accordance with a preferred embodiment of the present invention;

FIG. 3a is a schematic circuitry illustrating a simplified structure and a related circuitry of a first cell module of the systolic squarer in accordance with the preferred embodiment of the present invention;

FIG. 3b is a schematic circuitry illustrating a simplified structure and a related circuitry of a second cell module of the systolic squarer in accordance with the preferred embodiment of the present invention;

FIG. 3c is a schematic circuitry illustrating a simplified structure and a related circuitry of a third cell module of the systolic squarer in accordance with the preferred embodiment of the present invention;

FIG. 3d is a schematic circuitry illustrating a simplified structure and a related circuitry of a fourth cell module of the systolic squarer in accordance with the preferred embodiment of the present invention;

FIG. 3e is a schematic circuitry illustrating a simplified structure and a related circuitry of a fifth cell module of the systolic squarer in accordance with the preferred embodiment of the present invention; and

FIG. 4 is a schematic circuitry illustrating the systolic squarer having five classes of cells in accordance with the preferred embodiment of the present invention.

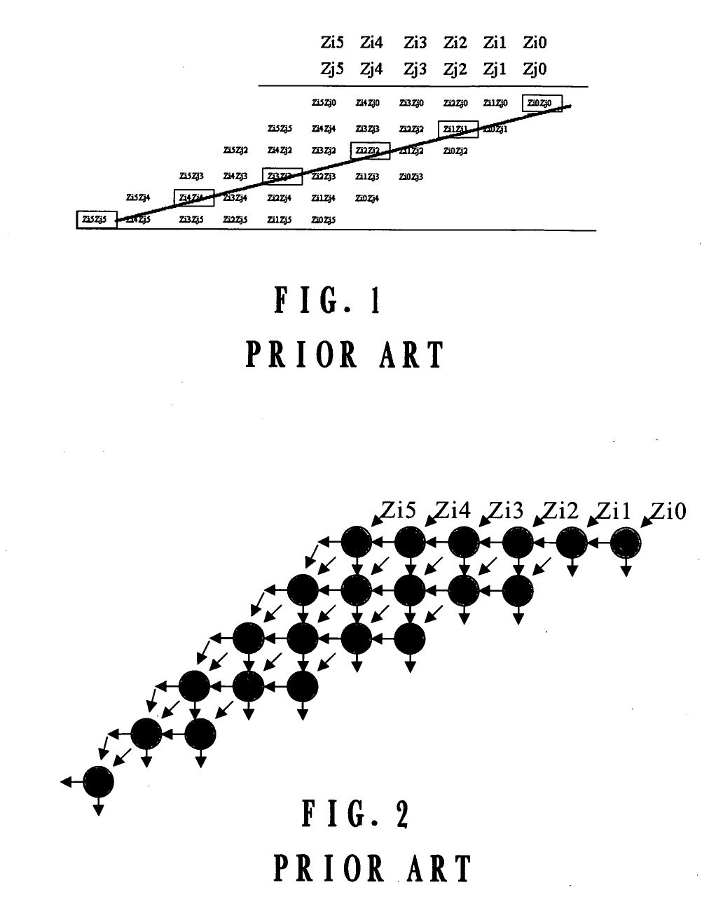

### DETAILED DESCRIPTION OF THE INVENTION

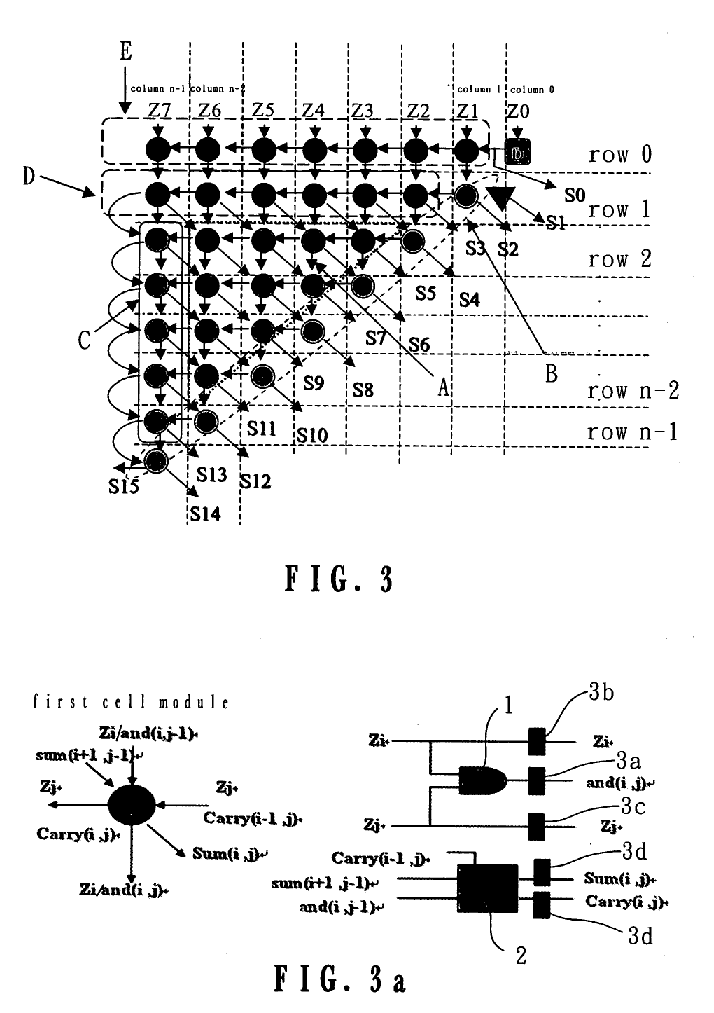

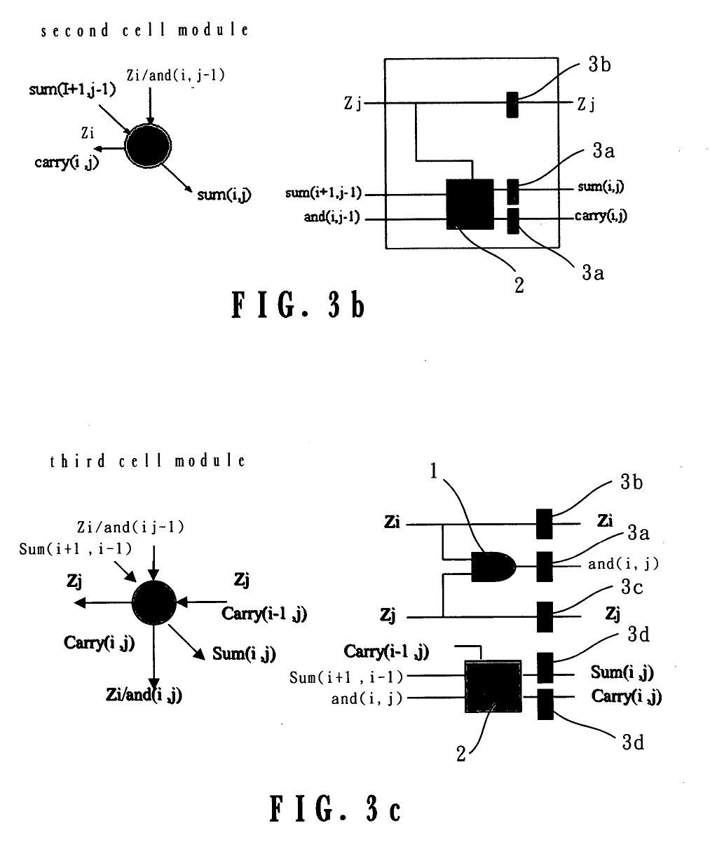

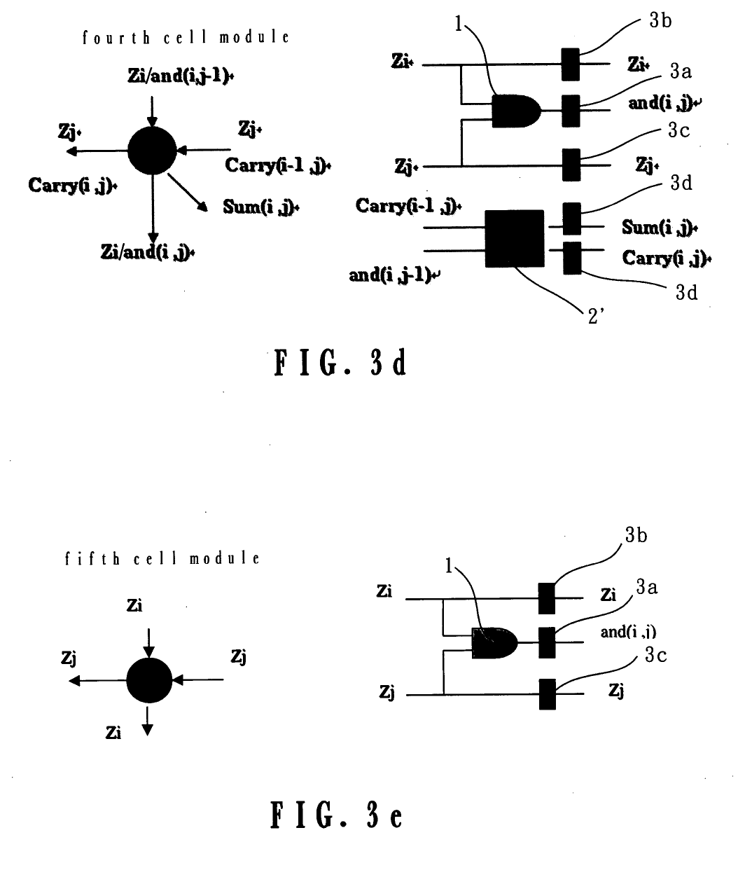

Turning now to FIG. 3, a systolic squarer with an 8-bit structure having five classes of cells in accordance with a preferred embodiment of the present invention is illustrated. An input terminal of the systolic squarer includes eight bits of Z7, Z6, Z5, Z4, Z3, Z2, Z1, Z0, a pulse signal line, a realignment line, a power line, and a ground line S1. Input data may be classified by pipeline and regulation according to each operational circuit. An output terminal of the systolic squarer includes sixteen bits of S0, S2, . . . , S15 to thereby constitute first to fifth cell modules identified as “A”, “B”, “C”, “D” and “E”.

Turning now to FIG. 3a, a simplified structure and a related circuitry of a first cell module of the systolic squarer is illustrated in detail. Each of the first cell modules typically includes an AND gate 1 and a full adder 2 combined together. Each of the first cell modules comprises an up input (Zi), a right input (Zj), an and input (and (i, j−1)), a sum input (sum (i+1, j−1)), a carry input (carry (i−1, j)), a down output (Zi), a left output (Zj), an and output (and (i,j)), a sum output (sum (i,j)) and a carry output (carry (i,j)). The up input and the right input correspondingly connect to two input ends of the AND gate 1 while an output end of the AND gate 1 connects with an input end of a D flip-flop 3a so that an output end of the D flip-flop 3a provides with the and output of the first cell module. The up input further connects to an input end of a D flip-flop 3b so that an output end of the D flip-flop 3b provides with the down output of the first cell module. The right input connects to an input end of a D flip-flop 3c so that an output end of the D flip-flop 3c provides with the left output of the first cell module.

Still referring to FIG. 3a, the and input, the sum input, and the carry input of the first cell module correspondingly connect to three input ends of the full adder 2 while two output ends of the full adder 2 correspondingly connect to two input ends of two D flip-flops 3d so that two output ends of the two D flip-flops 3d provide with the sum output and the carry output of the first cell module respectively. Accordingly, all first cell modules are permitted being connected each other, and the D flip-flops 3a, 3b, 3d are used for registering signal data.

Turning now to FIG. 3b, a simplified structure and a related circuitry of a second cell module of the systolic squarer is illustrated in detail. Each of the second cell modules typically includes a full adder 2. Each of the second cell modules comprises an up input (Zi), an and input (and (i, j−1)), a sum input (sum (i, j−1), a left output (Zj), a sum output (sum (i,j)) and a carry output (carry (i,j)). The up input and the and input correspondingly connect to two input ends of two D flip-flops 3a so that two output ends of the D flip-flop 3a provides with the sum output and the carry output of the second cell module. The up input further connects to an input end of a D flip-flop 3b so that an output end of the D flip-flop 3b provides with the down output of the second cell module. Accordingly, all second cell modules are permitted being connected each other.

Turning now to FIG. 3c, a simplified structure and a related circuitry of a third cell module of the systolic squarer is illustrated in detail. Each of the third cell module typically includes an AND gate 1 and a full adder 2 combined together. Each of the third cell modules comprises an up input (Zi), a right input (Zj), an and input (and (i, j−1)), a sum input (sum (i+1, j−1)), a carry input (carry (i−1, j)), a down output (Zi), a left output (Zj), an and output (and (i,j)), a sum output (sum (i,j)) and a carry output (carry (i, j)). The up input and the right input correspondingly connect to two input ends of the AND gate 1 while an output end of the AND gate 1 connects with an input end of a D flip-flop 3a so that an output end of the D flip-flop 3a provides with the and output of the third cell module. The up input further connects to an input end of a D flip-flop 3b so that an output end of the D flip-flop 3b provides with the down output of the third cell module. The right input connects to an input end of a D flip-flop 3c so that an output end of the D flip-flop 3c provides with the left output of the third cell module.

Still referring to FIG. 3c, the and input, the sum input, and the carry input of the third cell module correspondingly connect to three input ends of the full adder 2 while two output ends of the full adder 2 correspondingly connect to two input ends of two D flip-flops 3d so that two output ends of the two D flip-flops 3d provide with the sum output and the carry output of the third cell module respectively. Accordingly, all third cell modules are permitted being connected each other.

Turning now to FIG. 3d, a simplified structure and a related circuitry of a fourth cell module of the systolic squarer is illustrated in detail. Each of the fourth cell modules typically includes an AND gate 1 and a half adder 2′ combined together. Each of the fourth cell modules comprises an up input (Zi), a right input (Zj), an and input (and (i, j−1)), a carry input (carry (i−1, j)), a down output (Zi), a left output (Zj), an and output (and (i,j)), a sum output (sum (i,j)) and a carry output (carry (i,j)). The up input and the right input correspondingly connect to two input ends of the AND gate 1 while an output end of the AND gate 1 connects with an input end of a D flip-flop 3a so that an output end of the D flip-flop 3a provides with the and output of the fourth cell module. The up input further connects to an input end of a D flip-flop 3b so that an output end of the D flip-flop 3b provides with the down output of the fourth cell module. The right input connects to an input end of a D flip-flop 3c so that an output end of the D flip-flop 3c provides with the left output of the fourth cell module.

Still referring to FIG. 3d, the and input and the carry input of the fourth cell module correspondingly connect to two input ends of the half adder 2′ while two output ends of the half adder 2′ correspondingly connect to two input ends of two D flip-flops 3d so that two output ends of the two D flip-flops 3d provide with the sum output and the carry output of the fourth cell module respectively. Accordingly, all fourth cell modules are permitted being connected each other.

Turning now to FIG. 3e, a simplified structure and a related circuitry of a fifth cell module of the systolic squarer is illustrated in detail. Each of the fifth cell modules typically includes an AND gate 1. Each of the fifth cell modules comprises an up input (Zi), a right input (Zj), a down output (Zi), a left output (Zj) and an and output (and (i,j)). The up input and the right input correspondingly connect to two input ends of the AND gate 1 while an output end of the AND gate 1 connects with an input end of a D flip-flop 3a so that an output end of the D flip-flop 3a provides with the and output of the fifth cell module. The up input further connects to an input end of a D flip-flop 3b so that an output end of the D flip-flop 3b provides with the down output of the fifth cell module. The right input connects to an input end of a D flip-flop 3c so that an output end of the D flip-flop 3c provides with the left output of the fifth cell module. Accordingly, all fifth cell modules are permitted being connected each other.

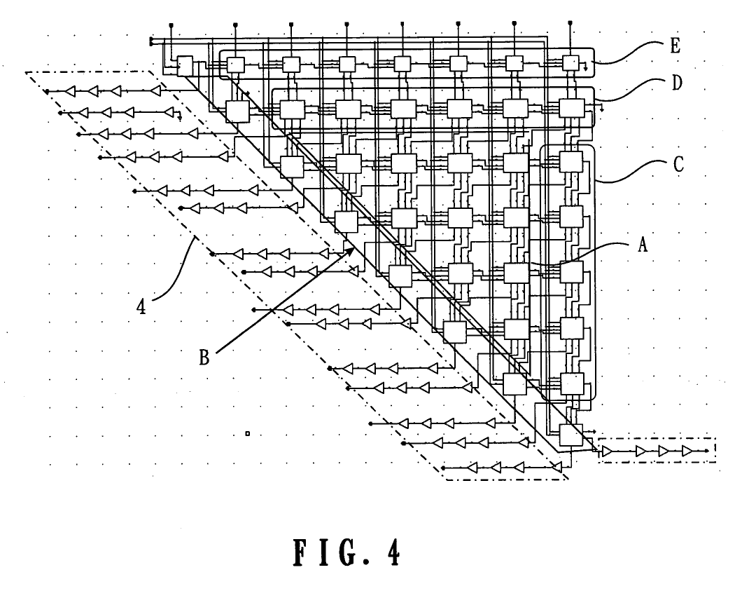

Turning now to FIG. 4, a schematic circuitry of the systolic squarer is illustrated in detail. The systolic squarer consists of multiple levers of the full adders. Each lever of the full adders connects to at least four buffers to constitute a super buffer in order to provide with adequate number of fan-outs that may prevent an output voltage of digital signals being weakened.

The square circuit of the systolic squarer in accordance with the present invention can still speed up the response rate, although there is a need for some operational time in filling up with data at the beginning of operation. Once the data are filled up, the systolic squarer can compute the square of a single numeral within a clock cycle.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A systolic squarer having five classes of cells comprising a systolic array classified into five cell modules by pipeline and regulation according to each operational circuit, thereby forming first cell modules, second cell modules, third cell modules, fourth cell modules and fifth cell modules, said first to fifth cell modules constitute a squarer circuit such that said first to fifth cell modules suitable for applying to process a great number of digital signals of data.

2. The systolic squarer having five classes of cells as defined in claim 1, wherein each of said cell modules is selected from a group consisting of plural full adders, plural half adders and plural AND gates.

3. The systolic squarer having five classes of cells as defined in claim 1, wherein said cell modules further comprises plural D flip-flops which used to lock data.

4. The systolic squarer having five classes of cells as defined in claim 1, further comprising plural buffer so as to provide with adequate number of fan-outs that may prevent an output voltage of digital signals being weakened.

5. The systolic squarer having five classes of cells as defined in claim 1, wherein each of said first cell modules includes an AND gate and a full adder; each of said first cell modules comprises an up input, a right input, an and input, a sum input, a carry input, a down output, a left output, an and output, a sum output and a carry output.

6. The systolic squarer having five classes of cells as defined in claim 1, wherein each of said second cell modules includes a full adder; each of said second cell modules comprises an up input, an and input, a sum input, a left output, a sum output and a carry output.

7. The systolic squarer having five classes of cells as defined in claim 1, wherein each of said third cell module includes an AND gate and a full adder; each of said third cell modules comprises an up input, a right input, an and input, a sum input, a carry input, a down output, a left output, an and output, a sum output and a carry output.

8. The systolic squarer having five classes of cells as defined in claim 1, wherein each of said fourth cell modules includes an AND gate and a half adder; each of said fourth cell modules comprises an up input, a right input, an and input, a carry input, a down output, a left output, an and output, a sum output and a carry output.

9. The systolic squarer having five classes of cells as defined in claim 1, wherein each of said fifth cell modules typically includes an AND gate; each of said fifth cell modules comprises an up input, a right input, a down output, a left output and an and output.

10. The systolic squarer having five classes of cells as defined in claim 1, further comprising plural D flip-flops, a pulse signal line, a realignment line, a power line, and a ground line.

11. A systolic squarer having five classes of cells selectively increasing or decreasing number of bits, thereby forming first cell modules, second cell modules, third cell modules, fourth cell modules and fifth cell modules, said first to fifth cell modules constitute a selected number of bits of a squarer circuit.
